(19) United States
(12) Patent Application Publication
(10) Pub. No.: US 2014/0292543 A1
(43) Pub. Date: Oct. 2, 2014

(54) MULTIDIMENSIONAL SYSTEM FOR MONITORING AND TRACKING STATES AND CONDITIONS

(71) Applicant: Iris Lahyani, Meltar (IL)

(72) Inventor: Iris Lahyani, Meltar (IL)

(73) Assignee: SOSMART RESCUE LTD, NETIVOT (IL)

(21) Appl. No.: 14/008,147

(22) PCT Filed: Mar. 28, 2011
(86) PCT No.: PCT/IL11/00280

§ 371 Date: Nov. 27, 2013

(51) Int. Cl. G08B 21/08; B63B 45/00; G08B 23/00

(52) U.S. Cl. CPC G08B 21/08; G08B 23/00; B63B 45/00
USPC 340/984; 340/539.22

(57) ABSTRACT

A monitoring system, which comprises (a) a set of sensors comprising one or more orientation sensors and at least a state sensor mounted on a body, or in a relation to the body, the motion and state of which are monitored, wherein each of orientation sensor defines orientation and/or coordinates, where each state sensor measures the required state as a function of time for making decision based on a combination of orientation and state parameters; (b) a transmitter coupled to the one or more position sensors; (c) a control system including a timer, a processor for processing the measurement results and making decisions regarding the orientation and state of the body and a memory for storing data and operating software. The first transmitter is operable to transmit output data from the one or more position sensors and the control system is operable to receive the data by the second transmitter and compared the data to the data stored in the memory means for searching abnormal states, as well as to activate an alert system coupled to the control system, whenever an abnormal state is detected.

### FIELD OF THE INVENTION

The present invention relates to the field of motion analysis. More particularly, the invention relates to a system for tracking an object by analyzing the output signal of one ore more multi-dimensional (e.g., 3-D or combination of 3D and other sensing parameter) motion sensors and detecting abnormal states of the body.

### BACKGROUND OF THE INVENTION

GPS navigation systems are very popular for tracking a person or a vehicle. However, location in the general meaning is related to 3 coordinates. In rescuing systems it is essential to know the third coordinate of location which normally is not provided by GPS systems. In these cases and for many other systems, using different types of sensors (e.g., a state sensor that can measure temperature, vibration/shaking, etc.) is more effective. The present invention aims to provide a multi-variant tracking system which uses a different type of location or orientation sensors (for example, a MEMS accelerometer MMA7660FC, Freescale Semiconductors) is adapted to provide three coordinates of location and relevant information regarding the spatial orientation of the monitored body.

Multi-dimensional motion sensors can detect changes in several dimensions that may include for example, moving to the left, right, up, down, front or back directions, as shown in FIG. 1. Such sensors can also provide information regarding other motion parameters, such as shaking.

The system of the present invention in most of its variants seeks for abnormal states and whenever an abnormal state is detected, automatically activates an alarm signal or activation of other system (such as communication, mechanical activity, electrical activity, etc.). The definition of an abnormal state is defined per application. Such a system can deal with many abnormal states or a combination of abnormal states, can be only passive (i.e., can deal with an early defined abnormal states) or can be adaptive (e.g., analyze abnormal state and create an abnormal state based on other abnormal early defined states).

Additionally, in lifesaving applications the accuracy of a GPS receiver is not sufficient. This raises the necessity in systems comprised of other location sensors.

For example, one of the scenarios when high accuracy tracking is needed is monitoring the position of one or more bathers in a beach area. In this case, in order to know if a person's life is in danger it is required to know (in addition to the planar location) his depth and inclination angle of the body. The planar coordinates of his location are required for alerting rescue personnel.

Another application for such a system could be for monitoring mountain climbers. The tracking history of a climber can provide highly important information regarding his condition. In case when a climber has fallen then the tracking system will detect that his altitude was decreased rapidly and then remained constant. A similar conclusion might be made if the orientation of the climber denotes that his head is pointed downwards. Such a tracking system can be adapted to detect these states as abnormal ones and activate an alarm or transmission when detected.

Monitoring a movable object might be useful for marine activities. A position and orientation monitoring system when placed on a buoy might give information of streams and waves in an area of interest.

As written above there is however a need in a tracking system which autonomously decides whether a person is in danger by identifying abnormal states and transmitting a distress signal if such a state is detected or activating other systems as the application is required to save the person.

Another application for the present invention is monitoring a marine vessel's position and orientation (mainly roll/pitch angle). If such a vessel is over-rolled the system identifies this condition as abnormal state and activates an alarm or a mechanical/electronic balancing system (such a system can activate a pump to load/release water from one side to other according to roll/pitch angle).

It is therefore an object of the present invention to provide a measurement system that initiates an action, such as data transmission, activation of a signal (electrical or acoustical) or activation of a mechanical or electrical inflation system.

It is also an object of the present invention to provide a system which is calculates three-dimensional velocity, acceleration and spatial orientation.

It is also an object of the present invention to provide a system which tracks the location, roll or pitch angle of a body.

Other objects and advantages of the invention will become apparent as the description proceeds.

### SUMMARY OF THE INVENTION

The present invention is directed to a monitoring system, that comprises:
(a) a set of sensors comprising one or more orientation sensors mounted on a body, or in a relation to the body, the motion of which is monitored, wherein each sensor measures orientation parameters as a function of time; and
(b) a processor for processing the measurement results and making decisions regarding the state of the body.

The present invention is also directed to a monitoring system, which comprises:
(a) a set of sensors comprising one or more orientation sensors and at least a state sensor mounted on a body, or in a relation to the body, the motion and state of which are monitored, wherein each of orientation sensor defines orientation and/or coordinates, where each state sensor measures the required state as a function of time for making decision based on a combination of orientation and state parameters;
(b) a transmitter coupled to the on e or more position sensors or a processor, for transmitting state data;
(c) a control system comprising:
(i) a timer;
(ii) a processor for processing the measurement results and making decisions regarding the orientation and state of the body; and
(iii) memory means,
wherein the transmitter is operable to transmit output data from the one or more position or state sensors.

The present invention is further directed to a monitoring system, which comprises:
(a) a set of sensors comprising one or more orientation sensors and at least a state sensor mounted on a body, or in a relation to the body, the motion and state of which are monitored, wherein each of orientation sensor defines orientation and/or coordinates, where each state sensor measures the required state as a function of time for making decision based on a combination of orientation and state parameters;
(b) a transmitter coupled to the one or more position sensors;
(c) a control system comprising:
(i) a timer;
(ii) a processor for processing the measurement results and making decisions regarding the orientation and state of the body; and
(iii) a memory for storing data and operating software,
wherein the first transmitter is operable to transmit output data from the one or more position sensors and the control system is operable to receive the data by the second transmitter and compared the data to the data stored in the memory means for searching abnormal states, wherein the c ontrol system is operable to activate an alert system coupled to the control system, whenever an abnormal state is detected.

The set of sensors may comprise one sensor, mounted on the body or in relation to the body of a mountain climber and operable to measure the altitude, where an abnormal state is an abrupt drop in the altitude followed by lack of movement. Alternatively, the set of sensors may comprise one sensor mounted on a vehicle, where the control system is operable to activate an alarm when an unauthorized person is moving the vehicle. In addition, the set of sensors may comprise two sensors mounted to a boat and operable to measure the roll angle of the boat, wherein the control system is adapted to transmit a distress signal whenever rollover of the boat is detected.

The set of sensors may include two sensors being mounted to a body, or in relation to the body, and operable to measure the location or state of a swimmer.

The set of sensors may include two sensors mounted to a body, or in relation to the body, and operable to measure the depth of a swimmer bellow the water surface.

The set of sensors may include two sensors mounted to a body or in relation to the body and operable to measure the angle of the body and of the water surface, where the control system is adapted to activate an alert system if at least one of the following occurs:
(a) the depth of the swimmer exceeds a predetermined threshold;
(b) the angle exceeds a predetermined threshold;
(c) the angle remains unchanged for longer that a predetermined period of time.

The features of all sensors in the set may be implemented in a single integrated circuit. These features may include: orientation, state, processing and transmission of data or of electrical signals or a memory.

Whenever a predetermined state is considered as abnormal, the control system may be operable to activate a mechanical system (with motion actuated by liquid, motion actuated by gas, motion actuated by solid parts, motion actuated by a lever, motion actuated by a spring, motion actuated by fireworks).

Whenever a predetermined state is considered as abnormal, the control system may also be operable to activate an electrical system, such as:
an alert system;
a communication device;
a visual system;
an audio system.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 (prior art) shows a multi-dimensional system for detecting changes in several dimensions;

FIG. 2 illustrates an exemplary motion history of a 3-D location sensor;

FIG. 3 schematically illustrates a three dimensional measurement of position as a function of time by the system of the present invention;

FIG. 4 generally illustrates the components of the system;

FIG. 5 is an example of an electrical embodiment of a MEMS accelerometer;

FIG. 6 generally illustrates the system of the present invention implemented to monitor the location and inclination angle of a swimmer; and

FIG. 7 is a graph describing the altitude of a mountain climber as being recorded by the control system.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

In order to better understand the invention, the following description regarding vectorial representation of states:

Vecorial representation uses vectors in a Cartesian or a polar coordinate system.

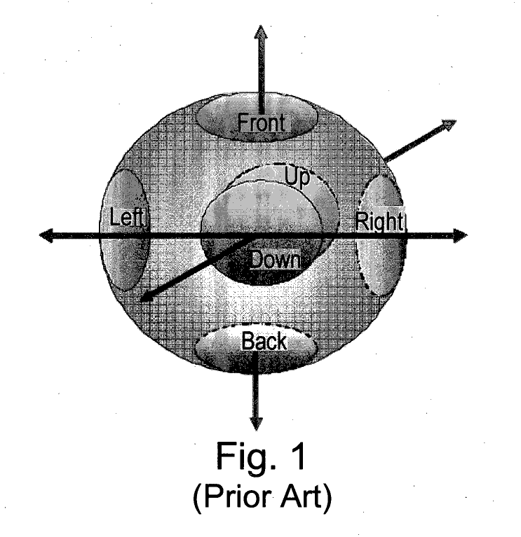

Cartesian Coordinate System (Shown for Example, in FIG. 1):

Each vector may be represented by the sum Ax\hat{x}+Ayŷ+Az\hat{z}, where Ax, Ay and Az are the magnitudes of the vector in x, y and z directions, respectively and \hat{x}, ŷ and \hat{z} are unity vectors in x, y and z directions, respectively. Also, the magnitude of the vector is A=\sqrt{(Aₓ)²+(A_{y})²+(A_{z})²}.

Polar Coordinate System:

In a 2-D system, each vector \vec{r} may be represented by the sum of its components \vec{x}=r cos θ and \vec{y}=r sin θ in x and y directions, respectively, where r=\sqrt{|\vec{x}|²+|\vec{y}|²} is the magnitudes of the vector and B is the direction (azimuth) in a 2-D system. Similar representation may be implemented for a 3-D system.

The location, velocity and acceleration of an entity are given by vector representations:

If the vector \vec{r}(t) represents the location of the entity in time t, then: Vector

$$\vec{v} ( t ) = \frac{\partial \vec{r}}{\partial t} = \dot{\vec{r}}$$

represents its velocity (location variation rate, as a function of t) and vector

$$\vec{a} ( t ) = \frac{{\partial }^{2} \vec{r}}{\partial {t}^{2}} = \ddot{\vec{r}} = \dot{\vec{v}}$$

represents its acceleration (velocity variation rate, as a function of t).

The magnitude of the speed vector \vec{v} is V=\sqrt{(Vₓ)²+(V_{y})²+(V_{z})²}. The speed vector \vec{v} is determined by changes in the direction and magnitude of \vec{r}. Given \vec{a}(t), it is possible to calculate the velocity and the location as an integral over the acceleration function \vec{a}(t) (with an accuracy of a constant which for the sake of clarity has been chosen as zero). In digital systems, the acceleration \vec{a}(t) is actually calculated from samples (numerical numbers), where every two samples generate a figure that represents the point measurement. Hence, it is easy to integrate over these points (according to the time interval which is equal to the sampling interval and the constant which was chosen to be zero) and calculate \vec{a}(t). Numerical integration methods are well known in the art and for the sake of clarity, an example will be described later. In a digital system, the constant that was chosen to be zero can be calculated, based on early information, such as earlier value of the result, or may be based on two spaced results and difference.

If the movement is circular, it can be represented by a radial unity vector \hat{R} representing the location in the entity's direction and an angular unity vector \hat{θ}, which is perpendicular to \hat{R} and represents the velocity in the perpendicular direction. The angular velocity ω(t) represents the change in the angle of the entity as a function of t, where

$$ω = \frac{d θ}{d t} .$$

In this case, the speed vector \vec{v} is given by

$$\vec{v} = \frac{d \vec{r}}{d t} \hat{R} + r \frac{d \vec{θ}}{d t} \hat{θ} .$$

Again, numerical integration over \vec{v} will generate \vec{r} (up to a constant), it should be emphasized that in this case the integration is done over a close path (line integral).

The present invention is dedicated for tracking a body in motion or in relation to said body and detecting abnormal states. The system proposed by the present invention is comprised of one or more location sensors and/or orientation sensors, which are mounted to the desired body which is needed to be monitored.

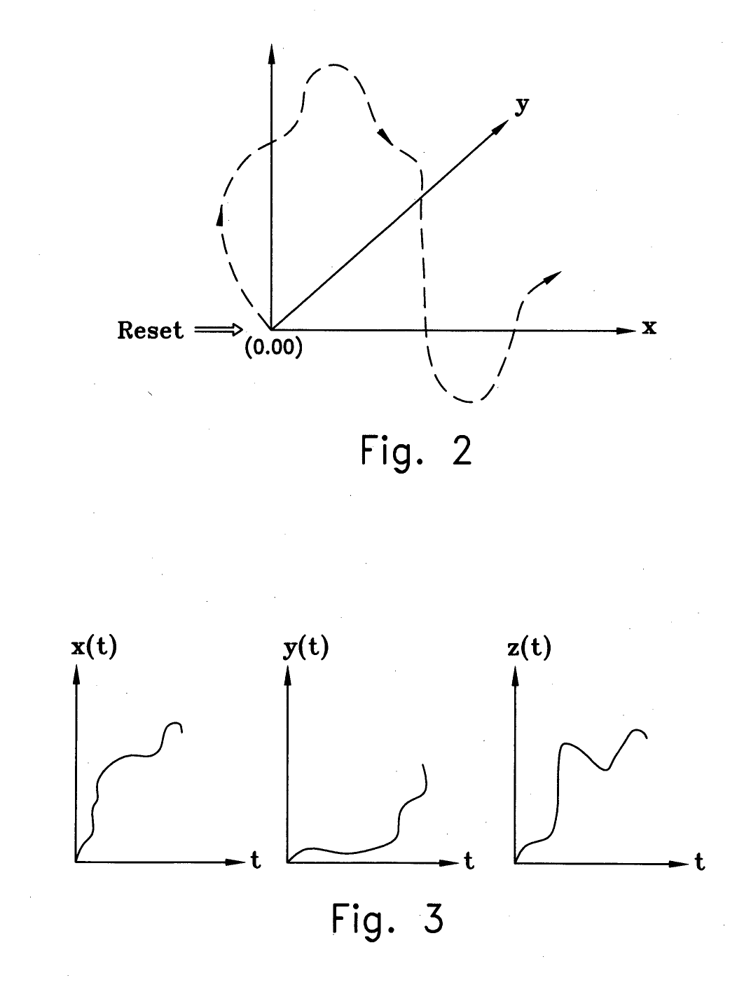

Referring now to the figures, FIG. 2 illustrates an example of the path of a location sensor. Each dot in the path is measured at a specific instant.

FIG. 3 illustrates the coordinates transmitted by an exemplary location sensor as a function of time. Accordingly, knowing the position or in relation to said position and state of an entity in a 2-D or 3-D Cartesian or a polar coordinate system, it is possible to measure the instantaneous changes in its displacement, its velocity or its acceleration (deceleration), in any dimension, including without limitation the linear, radial or nonlinear movements and shaking. Therefore, any change in any dimension including, without limitation, combinations of these changes, allows determining the 3-D state of the measured entity. These instantaneous changes in each dimension may be measured by a clock and the measurement results may be used to calculate the displacement, velocity or acceleration (deceleration), in any dimension using a numerical derivative of a first order (for velocity) or of a second order (for acceleration). These calculations are sufficiently accurate for relatively slow changes. In addition, in some cases, compensation for temperature or atmospheric pressure can be easily added to the computations by using it in the processor or as an internal part of the sensor. The features of all sensors in a set may be implemented in a single integrated circuit (e.g., an ASIC). Such features may be orientation (i.e., orientation parameters, such as tilt, angle relative to a reference plane, position), state (i.e., motion parameters such as displacement, speed, acceleration), processing, transmission of data or of electrical signals and a memory. Thus, instead of using several sensors or chips that implement each feature, a single ASIC component with or without a driver for display can be easily implemented.

In case of numerical calculations, it is possible to uniformly sample the clock or when the data rate increases, in a non-uniform manner. It is possible to use a single clock for all dimensions, or a different clock for each dimension with a synchronization circuit or differential measurements of the clocks. Time sampling may be done at a rate which is at least 2 times Nyquist frequency (i.e., twice faster for each dimension) to eliminate sampling errors and reconstruction of the integral as the application may need.

For example, if the location of a monitored body is given by x=x(tᵢ); y=y(tᵢ); z=z(tᵢ) and the body starts to move at time t_{begin} at intervals of Δt and ends its movement at time t_{end}, then the movement time t_{end}−t_{begin}, is sampled using N samples, where:

$$Δ t = \frac{{t}_{end} - {t}_{begin}}{N} ; {t}_{end} = {t}_{begin} + i Δ t ( i = 0 , 1 , … , N - 1 )$$

The movement time interval will be sampled using N samples and the displacement interval will be sampled using N samples, as well. Each element along the displacement path includes the location coordinates (measured by the sensor) as a function of time sample tᵢ. Derivation of subsequent samples on the displacement path yields the velocity and further derivation yields the acceleration. Therefore, it is possible to accurately determine the state of the entity as a function of time samples tᵢ, for making decisions.

The opposite calculation is also possible using samples of an acceleration sensor, every two sample with interval Δt can be integrated to generate the velocity, another integration (using constant calculated as zero or as point of reference or as measured and therefore the constant is approximated as the old results and a difference equation can calculate the real constant value) will yield the location variation in each dimension.

Numerical Integration:

Numerical integration is an approximate computation of an integral operator, using numerical techniques. The numerical computation of an integral is sometimes called quadrature. Ueberhuber (1997, p. 71) uses the word “quadrature” to mean numerical computation of a univariate integral, and “cubature” to mean numerical computation of a multiple integral. There is a wide range of methods available for numerical integration, such as Press et al. (1992). The most straightforward numerical integration technique uses the Newton-Cotes formulas (also called quadrature formulas), which approximate a function tabulated at a sequence of regularly spaced intervals by various degree polynomials. If the endpoints are tabulated, then the 2- and 3-point formulas are called the trapezoidal rule and Simpson's rule, respectively. The 5-point formula is called Boole's rule. A generalization of the trapezoidal rule is Romberg integration, which can yield accurate results for many fewer function evaluations.

Numerical Differentiation:

With respect to numerical differentiation, there are several methods suitable for different scenarios. A famous formula for calculating a derivative in a middle point x₁ based in three points or samples (x₀, x₁ and x₂) is the Lagrange's method:

$$\begin{matrix}df \\ dx\end{matrix} {\vert}_{x = {x}_{1}} \approx \begin{matrix}( {x}_{1} - {x}_{2} ) \\ ( {x}_{0} - {x}_{1} ) ( {x}_{0} - {x}_{2} )\end{matrix} f ( {x}_{0} ) + [ \begin{matrix}1 \\ ( {x}_{1} - {x}_{2} )\end{matrix} + \begin{matrix}1 \\ ( {x}_{1} - {x}_{0} )\end{matrix} ] f ( {x}_{1} ) + \begin{matrix}( {x}_{1} - {x}_{0} ) \\ ( {x}_{2} - {x}_{0} ) ( {x}_{3} - {x}_{1} )\end{matrix} f ( {x}_{2} ) .$$

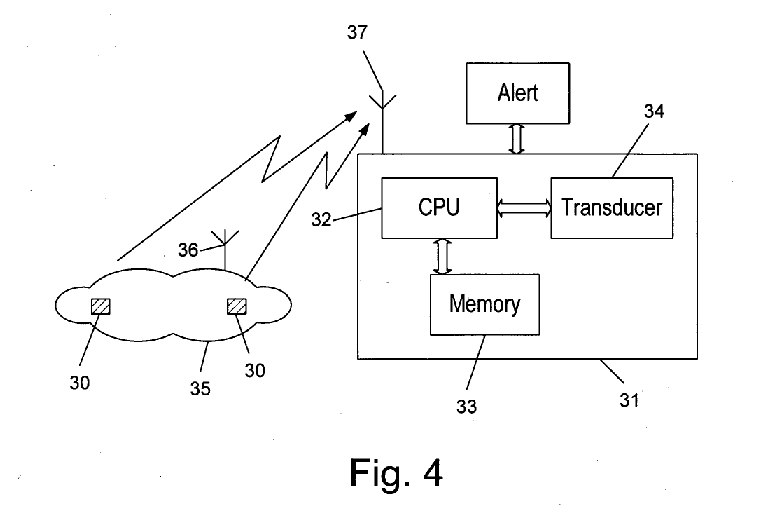

As described in FIG. 4, one possible implementation of the system proposed by the present invention consists of at least one sensor (or a set of several sensors) 30 coupled to a transceiver 34, which transmits its location to a control system 31. One sensor is measuring the state along the X axis and the other sensor is measuring the state along the Z axis (in a polar coordinates system, the sensors are measuring \hat{R} and \hat{θ}). The control system 31 is comprised of a processor 32, memory means and a transceiver. The transceiver 34 is operable to receive location information transmitted by the sensor's transmitter and process the data in order to detect abnormal states. An abnormal state is defined according to the specific implementation of the system. Exemplary implementations and the definition of an abnormal state are fully described bellow. When an abnormal state is detected an alarm is activated. Alternatively, the sensors may be coupled to other devices or systems which may be operated using mechanical/electrical activation, according to the type of implementation, for example coupled to a lever that releases gas, or an electronic circuit for a battery that connects a flash light, or a system that send fireworks. As seen in this figure, one or more location sensors are mounted to a monitored body 35. All the sensors are associated to a timer, such that a simultaneous reading is received. As will be described further on, analysis of the data received from a position sensor 30 or other state sensor (for example shake sensor) may give a variety of information types depending on the application. The position sensors 30 in the present invention are operated to work simultaneously with the control system 31. The location sensors 30 are connected to the antenna 36 which transmits the readings of the sensor(s) to the antenna 37 of the control system. In addition, the control system 31 comprises a processor 32 and memory means 33. The memory means 33 store information regarding abnormal states of the monitored object 35.

The state condition can be chosen as the velocity or acceleration instead of the location. For example, the instantaneous velocity may be calculated by dividing the difference between the positions in two subsequent measurements, with the time interval between the measurements. In the same manner, the three components of acceleration may be also calculated. Depending on the particular application of the system, the relevant information will be calculated from the readings of one or more position sensors and the abnormal state is analyzed.

In addition, combination of sensors might generate different decision but an interesting situation can occur when measurement based on only one sensor can activate other systems or generate an alert, for example, if a monitored body is shaking this might causes the system to decide that an emergency situation occurred and therefore, a decision is to send a signal is made. An alert may also be generated when the depth or the angle of a swimmer exceeds a predetermined threshold, or when the angle remains unchanged for longer that a predetermined period of time.

In another example, if a person fall to water from a boat, it is possible based on the accelerometers (which might be attached to the body itself or in relation to said body—for example on its bag or other accessory), to define the state of the body (according to the methods described above). It is possible also to perform state decision according to the different measurements in one of the X, Y or Z orientation or a combination thereof and to decide if to inflate its life suite. In addition, it is also possible to decide on a state where partial body is in water by measuring its pressure sensor and it is possible to measure shaking condition (in cold water) and to make decision (regardless of other sensors) to inflate the life suite. The control system is also operable to restart measurement process either automatically or manually.

In the above example of monitoring a swimmer or a diver, information about the person's inclination of body is required. The location of the upper sensor relative to the location of the upper sensor is calculated by subtraction of location received from the location received from the lower location. It is however, possible to use one sensor and to measure, on a time bases interval, the UP orientation vis-à-vis the DOWN ordination (the differences) and therefore, make decision whether the state is normal or abnormal.

Generally, attitude (orientation) of a rigid body is defined represented by several possible ways which all use three parameters in order to determine a rigid body's attitude. Orientation of the monitored body can be determined by the data given for example in Table I, which is extracted from the data sheet of a MEMS accelerometer (Freescale Semiconductors MMA7660FC). In this context it is possible to analyze each one of the orientations including or excluding the shaking state, in order to make decision for further action.

TABLE I

| Orientation | Xg | Yg | Zg |
|---|---|---|---|
| Shake | \|X\| > +1.3 g or | \|Y\| > +1.3 g or | \|Z\| > +1.3 g |
| Up | \|Z\| < 0.8 g and | | |
| | \|X\| > \|Y\| | | |
| | and X < 0 | | |
| Down | \|Z\| < 0.8 g and | | |
| | \|X\| > \|Y\| | | |
| | and X > 0 | | |
| Right | | \|Z\| < 0.8 g and \|Y\| > \|X\| | |
| | | and Y < 0 | |
| Left | | \|Z\| < 0.8 g and \|Y\| > \|X\| | |
| | | and Y > 0 | |
| Back | | | Z < −0.25 g |
| Front | | | Z > 0.25 g |

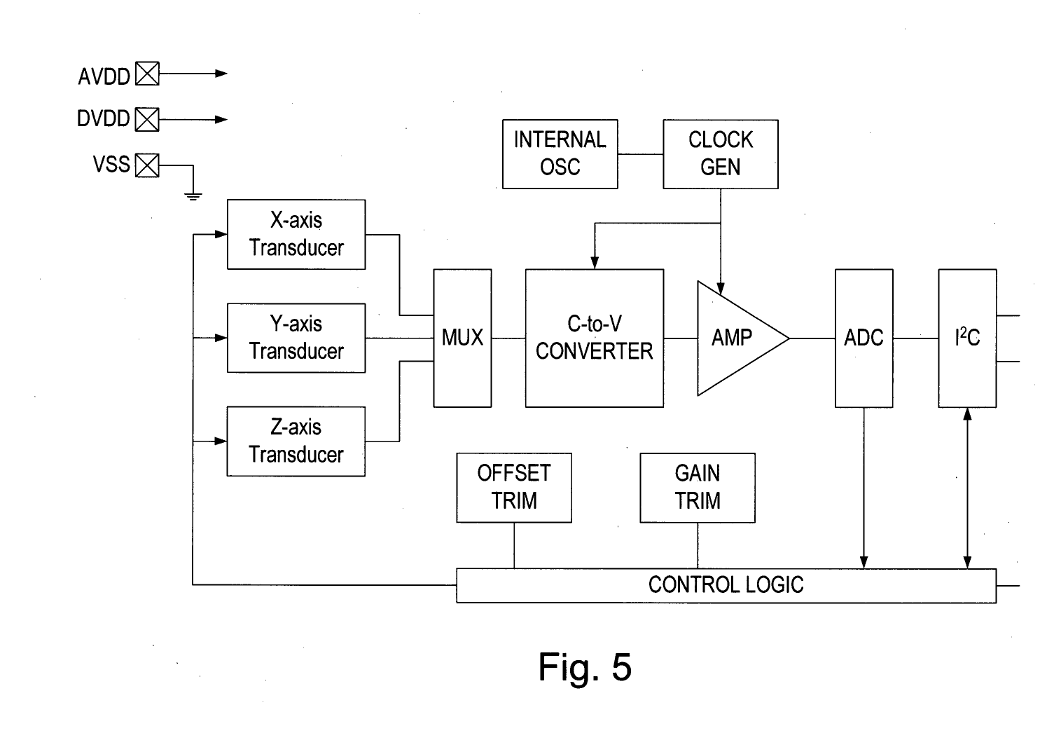

FIG. 5 is an example of electrical embodiments of a MEMS accelerometer, with sampling and communication protocol (for example, an PC bus protocol—is a serial and synchronous bus protocol). The drawing illustrates a simple implementation of three orientations readings (X, Y, Z), sampled (by the ADC) through a multiplexer (that receives a signal and synchronization data from a logic circuit). The signal is converted thorough a C-V converter (a current-to-voltage converter is an electrical device that takes an electric current as an input signal and produces a corresponding voltage as an output signal), amplified and sent via the serial communication channel.

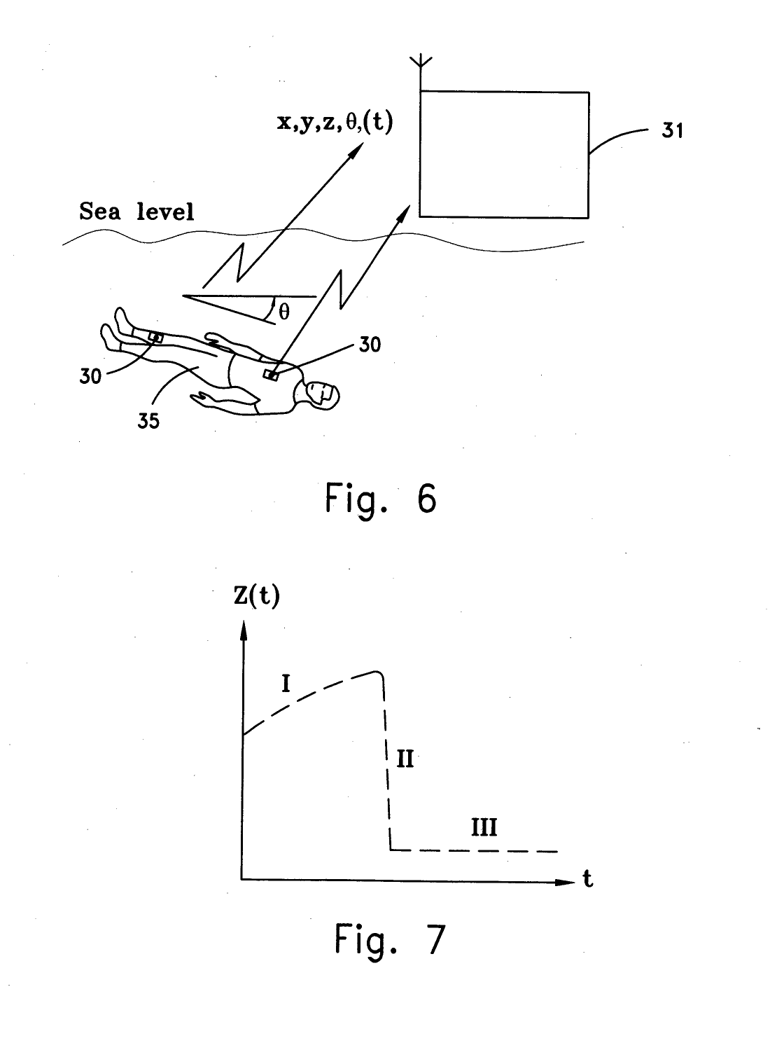

For the purpose of drowning detection or rollover of a marine vessel detection (such as a boat), only partial information is needed. In other words, only one angle of inclination (pitch angle) is important, as shown in FIG. 6.

One of the usages of the system of the present invention is drowning detection. In this case, in addition to the location of the person (a swimmer, a person sailing on a boat or a diver) it is also essential for the system to provide information regarding the depth and body orientation (a set of sensors may be mounted to a body or in relation to the body and operable to measure the depth of a swimmer bellow the water surface).

Another usage is to transmit a distress signal whenever rollover of a boat or of a vehicle is detected.

FIG. 7 is a graph describing the altitude of a mountain climber as being recorded by the control system. In section I it seems that the climber is gradually increasing his altitude. Section II indicates of a sudden negative change in altitude (falling down). Section III indicates that the altitude of the climber remains constant (on the ground). The control system automatically identifies it as an abnormal state and activated the alarm module.

According to another embodiment, a set of sensors comprises one sensor being mounted on a vehicle, for activating an alarm when an unauthorized person is moving the vehicle.

According to another embodiment, the control system may activate a mechanical system, whenever a predetermined state is considered as abnormal. Such mechanical system may be motion actuated by liquid, motion actuated by gas, motion actuated by solid parts, motion actuated by a lever, motion actuated by a spring or motion actuated by fireworks.

According to another embodiment, the control system may activate an electrical system (such as an alert system, a communication device, a visual system or an audio system), whenever a predetermined state is considered as abnormal.

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

### REFERENCES

Corbit, D. “Numerical Integration: From Trapezoids to RMS: Object-Oriented Numerical Integration.” Dr. Dobb's J., No. 252, 117-120, October 1996.
Davis, P. J. and Rabinowitz, P. Methods of Numerical Integration, 2nd ed. New York: Academic Press, 1984.
Hildebrand, F. B. Introduction to Numerical Analysis. New York: McGraw-Hill, pp. 319-323, 1956.
Krommer, A. R. and Ueberhuber, C. W. Numerical Integration on Advanced Computer Systems. Berlin: Springer-Verlag, 1994.
Milne, W. E. Numerical Calculus: Approximations, Interpolation, Finite Differences, Numerical Integration and Curve Fitting. Princeton, N.J.: Princeton University Press, 1949.
Press, W. H.; Flannery, B. P.; Teukolsky, S. A.; and Vetterling, W. T. Numerical Recipes in FORTRAN: The Art of Scientific Computing, 2nd ed. Cambridge, England: Cambridge University Press, 1992.
Smith, J. M. “Recent Developments in Numerical Integration.” J. Dynam. Sys., Measurement and Control 96, 61-70, March 1974.
Ueberhuber, C. W. “Numerical Integration.” Ch. 12 in Numerical Computation 2: Methods, Software, and Analysis. Berlin: Springer-Verlag, pp. 65-169, 1997.
Weisstein, E. W. “Books about Numerical Methods.” http://www.ericweisstein.com/encyclopedias/books/NumericalMethods.htm 1.
Whittaker, E. T. and Robinson, G. “Numerical Integration and Summation.” Ch. 7 in The Calculus of Observations: A Treatise on Numerical Mathematics, 4th ed. New York: Dover, pp. 132-163, 1967.

1-39. (canceled)

40. A monitoring system, comprising:
(a) a set of sensors comprising one or more orientation or state sensors mounted on, or in a relation to, a body, the motion of which is monitored, wherein said set of sensors measures three-dimensional location and orientation parameters as a function of time, to generate a change in displacement, velocity or acceleration in any desired dimension; and
(b) a processor for processing measurement results and making decisions regarding the state of said body when said measurement results are indicative of a predetermined abnormal state.

41. A monitoring system according to claim 40, further comprising:
(a) a transmitter coupled to said set of sensors, for transmitting the measurement results; and
(b) a control system comprising:
(i) a timer;
(ii) the processor; and
(iii) memory means,
wherein said transmitter is operable to transmit output data from the set of sensors.

42. A monitoring system according to claim 40, wherein the body is a body of a mountain climber and the set of sensors is operable to measure a current altitude of the mountain climber, and wherein the abnormal state is an abrupt drop in the altitude, followed by lack of movement.

43. A monitoring system according to claim 41, wherein the body is a vehicle, and wherein the control system is operable to activate an alarm when an unauthorized person causes the vehicle to move.

44. A monitoring system according to claim 41, wherein the body is a boat and the set of sensors is operable to measure a roll angle of said boat, and wherein the control system is adapted to transmit a distress signal whenever rollover of the boat is detected.

45. A monitoring system according to claim 40, wherein the body is a swimmer and the set of sensors is operable to measure the location or state of said swimmer.

46. A monitoring system according to claim 45, wherein the set of sensors is operable to measure the depth of the swimmer below the water surface.

47. A monitoring system according to claim 45, wherein the set of sensors is operable to measure the angle of the swimmer with respect to the water surface,
wherein the control system is adapted to activate an alert system if at least one of the following occurs:
(a) the depth of the swimmer exceeds a predetermined threshold;
(b) said angle exceeds a predetermined threshold; and
(c) said angle remains unchanged for longer than a predetermined period of time.

48. A monitoring system according to claim 40, wherein features of all sensors in the set are implemented in a single integrated circuit.

49. A monitoring system according to claim 48, wherein the features are selected from the group consisting of orientation, state, processing, transmission of data or of electrical signals, and a memory.

50. A monitoring system according to claim 41, wherein the control system is operable to activate a mechanical system, whenever a predetermined state is considered as abnormal.

51. A monitoring system according to claim 50, wherein the mechanical system includes a mechanism for generating mechanical motion selected from the group consisting of:
motion actuated by liquid;
motion actuated by gas;
motion actuated by solid parts;
motion actuated by a lever;
motion actuated by a spring; and
motion actuated by fireworks.

52. A monitoring system according to claim 41, wherein the control system is operable to activate an electrical system, whenever a predetermined state is considered as abnormal.

53. A monitoring system according to claim 52, wherein the electrical system is selected from the group consisting of:
an alert system;
a communication device;
a visual system; and
an audio system.

54. A monitoring system according to claim 40, wherein each of the orientation sensors defines orientation and/or coordinates, and wherein each of the state sensors measures the required state as a function of time for making decision based on a combination of orientation and state parameters.

55. A monitoring system according to claim 41, wherein the transmitter is operable to transmit the output data from the set of sensors, and wherein the control system is operable to receive the output data by an additional transmitter, to compare said received data to data stored in the memory means in order to search for abnormal states, and to activate an alert system coupled to the control system, whenever an abnormal state is detected.

56. A monitoring system, comprising:
(a) a set of sensors comprising one or more orientation sensors and at least one state sensor mounted on a body, or in a relation to said body, the motion and state of which are monitored, wherein each of said one or more orientation sensors defines orientation and/or coordinates, wherein each of said at least one state sensor measures the required state as a function of time for making decision based on a combination of orientation and state parameters;
(b) a transmitter coupled to said one or more orientation sensors; and
(c) a control system comprising:
(i) a timer;
(ii) a processor for processing measurement results and making decisions regarding the orientation and state of said body; and
(iii) a memory for storing data and operating software.

57. A monitoring system according to claim 56, further comprising a transceiver and an alarm system coupled to the control system,
wherein the transmitter is operable to transmit output data from the one or more orientation sensors to said transceiver,
wherein the control system is operable to receive said output data by said transceiver, to compare said output data to the data stored in memory which defines abnormal states, and to activate said alert system whenever an abnormal state is detected.

58. A monitoring system according to claim 57, wherein the set of sensors comprises two sensors being mounted to the body or in relation to the body and is operable to measure an angle of the body with respect to a water surface,
wherein the control system is adapted to activate the alert system if at least one of the following occurs:
(a) the depth of a swimmer exceeds a predetermined threshold;
(b) said angle exceeds a predetermined threshold; and
(c) said angle remains unchanged for longer than a predetermined period of time.

59. A monitoring system according to claim 57, wherein the control system is also operable to activate a mechanical system, a communication device, a visual system, or an audio system whenever an abnormal state is detected.
